(19) United States
(12) Patent Application Publication
(10) Pub. No.: US 2013/0333509 A1
(43) Pub. Date: Dec. 19, 2013

(54) WRIST CONFIGURATION UNIT OF INDUSTRIAL ROBOT

(71) Applicant: FANUC CORPORATION, Yamanashi (JP)

(72) Inventor: Satoshi ADACHI, Yamanashi (JP)

(73) Assignee: FANUC CORPORATION, Yamanashi (JP)

(21) Appl. No.: 13/872,791

(22) Filed: Apr. 29, 2013

(30) Foreign Application Priority Data
Jun. 15, 2012 (JP) 2012-135611

(51) Int. Cl. B25J 17/02

(52) U.S. Cl. CPC B25J 17/0241; Y10S 901/29
USPC 74/490.03; 901/29

(57) ABSTRACT

A spur-gear speed-reduction mechanism unit includes a first spur gear attached to an output shaft of a wrist inner frame driving motor, a second spur gear rotatably supported by a first auxiliary shaft attached to a wrist housing machine frame, a third spur gear rotatably supported by the first auxiliary shaft to be integrated with the second spur gear, a fourth spur gear rotatably supported by a second auxiliary shaft, a fifth spur gear rotatably supported by the second auxiliary shaft to be integrated with the fourth spur gear, a sixth spur gear rotatably supported by a third auxiliary shaft, a seventh spur gear attached to a rotational shaft of the wrist inner frame and engaging the sixth spur gear. A distance between the fourth spur gear and the wrist housing machine frame is smaller than a distance between the first spur gear and the wrist housing machine frame.

### BACKGROUND OF THE INVENTION

1. Field of the Invention

The present invention relates to a wrist configuration unit of an industrial robot. In particular, the present invention relates to a wrist configuration unit provided at the tip of an industrial robot arm.

2. Description of the Related Art

A wrist configuration unit of an industrial robot includes a wrist machine frame, and a wrist inner frame that can be rotated relative to the wrist machine frame. A wrist element such as a hand and a tool is attached to the wrist inner frame via a working tool attachment unit. A driving motor is incorporated into the wrist inner frame. The driving motor includes an output shaft of which rotation is decelerated by a spur-gear speed-reduction mechanism unit so that the wrist inner frame can be rotated relative to the wrist machine frame.

According to Japanese Unexamined Patent Publication No. 7-52074, a spur-gear speed-reduction mechanism unit is positioned on one side of a wrist machine frame, and includes a multistage spur gear row. In the spur-gear speed-reduction mechanism unit, an output spur gear that can be rotated on an operational axis of a wrist inner frame engages a small diameter spur gear that can be rotated on an auxiliary axis. Integrally formed with the small diameter spur gear is a large diameter spur gear. Japanese Unexamined Patent Publication No. 6-297377 also discloses a speed-reduction mechanism unit including approximately the same configuration as the above-described configuration.

According to Japanese Unexamined Patent Publication No. 7-52074, in order to minimize a gap in the rotational-axis direction of the wrist inner frame between the wrist machine frame and the above-described small diameter spur gear, the above-described large diameter spur gear is arranged at a position distant from a center axis of the wrist machine frame. Accordingly, the spur-gear speed-reduction mechanism unit protrudes to an outside from one side of the wrist machine frame in the rotational-axis direction of the wrist inner frame. As a result, a cover that covers a speed reducer room extends to the outside, as well. Accordingly, in the prior art, a width of the wrist machine frame in the rotational-axis direction of the wrist inner frame is large. For this reason, there is a problem in that an interference radius when seen from a front side of the wrist is large, as well.

In view of such a problem, the present invention was made. An object of the present invention is to provide a wrist configuration unit of an industrial robot in which a width of a wrist machine frame in a rotational-axis direction of a wrist inner frame is decreased so that an interference radius when seen from a front side of a wrist can be decreased.

### SUMMARY OF THE INVENTION

In order to accomplish the above-described object, according to a first aspect, there is provided a wrist configuration unit that is connected to a tip of an arm of a robot, and that has a plurality of operational degrees of freedom, the wrist configuration unit including: a wrist housing machine frame that forms, in a wrist machine frame, different wrist rooms separated from each other; a wrist inner frame that is rotatably held in one wrist room of the wrist rooms; a wrist inner frame driving motor that drives the wrist inner frame, and that is arranged in another wrist room of the wrist rooms such that an output shaft of the wrist inner frame driving motor is parallel with a rotational axis of the wrist inner frame; an additional driving motor that is received in the wrist inner frame, and that outputs rotational output on an axis perpendicular to the rotational axis of the wrist inner frame; a cover that covers one side of the wrist housing machine frame, and that forms a speed reducer room; and a spur-gear speed-reduction mechanism unit that is arranged in the speed reducer room, and that decelerates a force of rotation output from the output shaft of the wrist inner frame driving motor, and transmits the force of the rotation to the wrist inner frame, wherein the spur-gear speed-reduction mechanism unit includes: a first spur gear attached to the output shaft of the wrist inner frame driving motor; a second spur gear that is rotatably supported by a first auxiliary shaft attached to the wrist housing machine frame, that has a diameter larger than a diameter of the first spur gear, and that engages the first spur gear; a third spur gear that is rotatably supported by the first auxiliary shaft so as to be integrated with the second spur gear, and that has a diameter smaller than the diameter of the second spur gear; a fourth spur gear that is rotatably supported by a second auxiliary shaft attached to the wrist housing machine frame, that has a diameter larger than the diameter of the third spur gear, and that engages the third spur gear; a fifth spur gear that is rotatably supported by the second auxiliary shaft so as to be integrated with the fourth spur gear, and that has a diameter smaller than the diameter of the fourth spur gear; a sixth spur gear that is rotatably supported by a third auxiliary shaft attached to the wrist housing machine frame, that has a diameter larger than the diameter of the fifth spur gear, and that engages the fifth spur gear; and a seventh spur gear that is attached to the rotational shaft of the wrist inner frame, and that engages the sixth spur gear, wherein the fourth spur gear is arranged such that a distance between the fourth spur gear and the wrist housing machine frame is smaller than a distance between the first spur gear and the wrist housing machine frame.

According to a second aspect, in the first aspect, a tip of the output shaft of the wrist inner frame driving motor protrudes outwardly rather than the first-to-seventh spur gears.

These objects, features and advantages, and other objects, features and advantages would become more apparent from detailed description of typical embodiments of the present invention that are illustrated in the attached drawings.

### BRIEF DESCRIPTION OF THE DRAWINGS

FIG. 1 illustrates an entire configuration of a robot that includes a wrist configuration unit based on the present invention;

FIG. 2 is a perspective view of the wrist configuration unit based on the present invention;

FIG. 3A is a sectional view of the wrist configuration unit based on the present invention;

FIG. 3B is a side view illustrating a state where a cover of the wrist configuration unit illustrated in FIG. 3A is detached; and

FIG. 3C is an end view when seen from a wrist tip of the wrist configuration unit illustrated in FIG. 3A.

### DETAILED DESCRIPTION

In the following, embodiments of the present invention will be described with reference to the attached drawings. In the drawings, the same reference symbols are attached to the same members. To facilitate understanding, the drawings are reduced in scale.

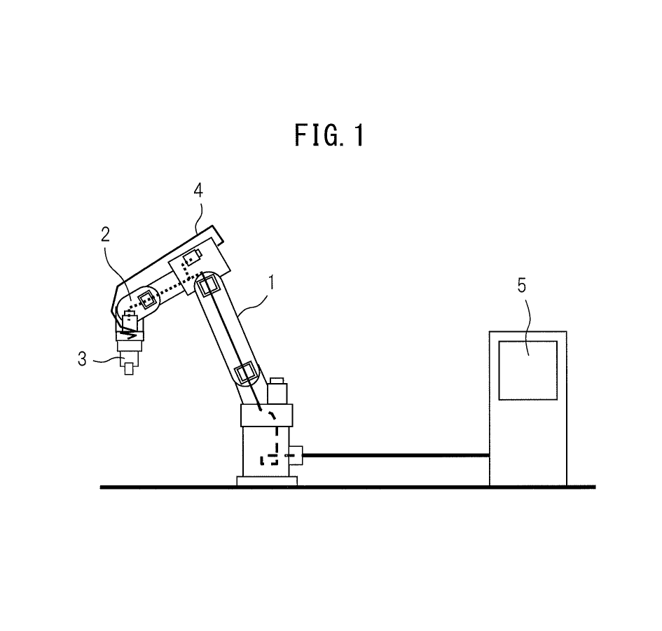

FIG. 1 illustrates an entire configuration of a robot that includes a wrist configuration unit based on the present invention. The robot 1 illustrated in FIG. 1 is a vertical articulated robot including six axes. A wrist 2 at a tip end of the robot 1 is installed so as to have six degrees of freedom. For each axis of the robot 1, a servomotor (not illustrated in FIG. 1) for driving the axis is incorporated. These servomotors are connected to a robot controller 5 by control cables that extend respectively from the servomotors. Each of the servomotors is controlled by the robot controller 5.

As illustrated in FIG. 1, attached to the tip end of the wrist 2 of the robot 1 is a working tool 3, for example, a gripper or a welding torch. The working tool 3 is used for holding or transferring a component, or welding a workpiece. An umbilical member 4 for the working tool illustrated in FIG. 1 is used for supplying electric power or air to the working tool 3.

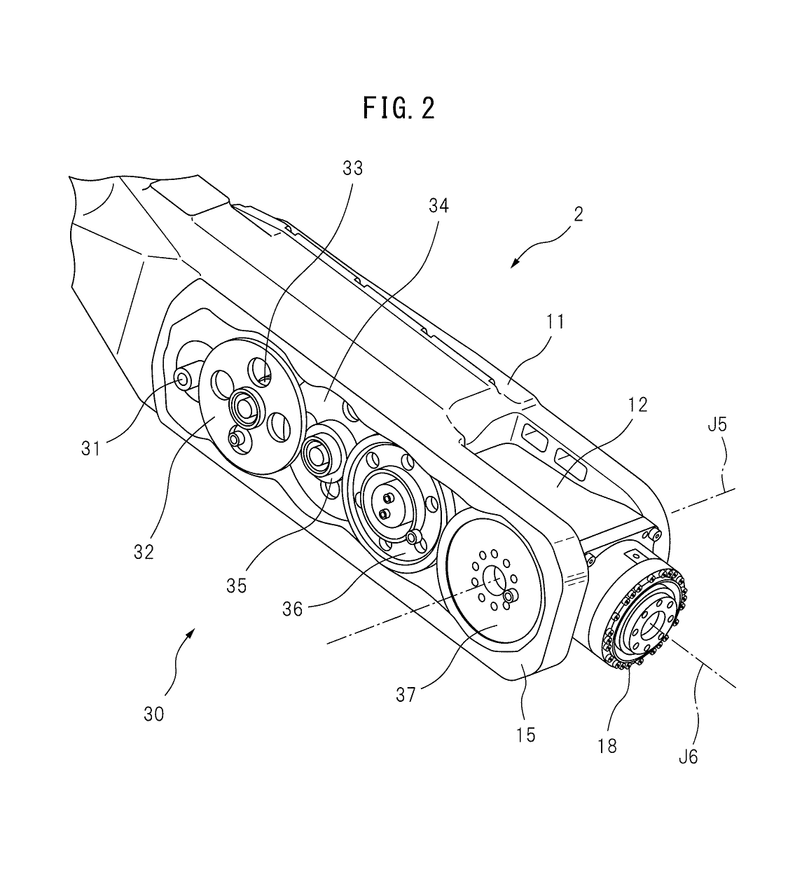

FIG. 2 is a perspective view of the wrist configuration unit based on the present invention. In FIG. 2, the wrist 2 mainly includes a wrist machine frame 11, and a wrist inner frame 12 that is attached to the wrist machine frame 11 such that the wrist inner frame 12 can rotate on an axis J5 relative to the wrist machine frame 11. The wrist inner frame 12 includes a working tool attachment unit 18, which is rotated on an axis J6, together with the working tool 3 (not illustrated in FIG. 2).

As illustrated in FIG. 2, to one side of the wrist machine frame 11, a cover 15 is attached. The cover 15 has a shape that is slightly curved outward. Between the cover 15 and the wrist machine frame 11, a spur-gear speed-reduction mechanism unit 30 is arranged.

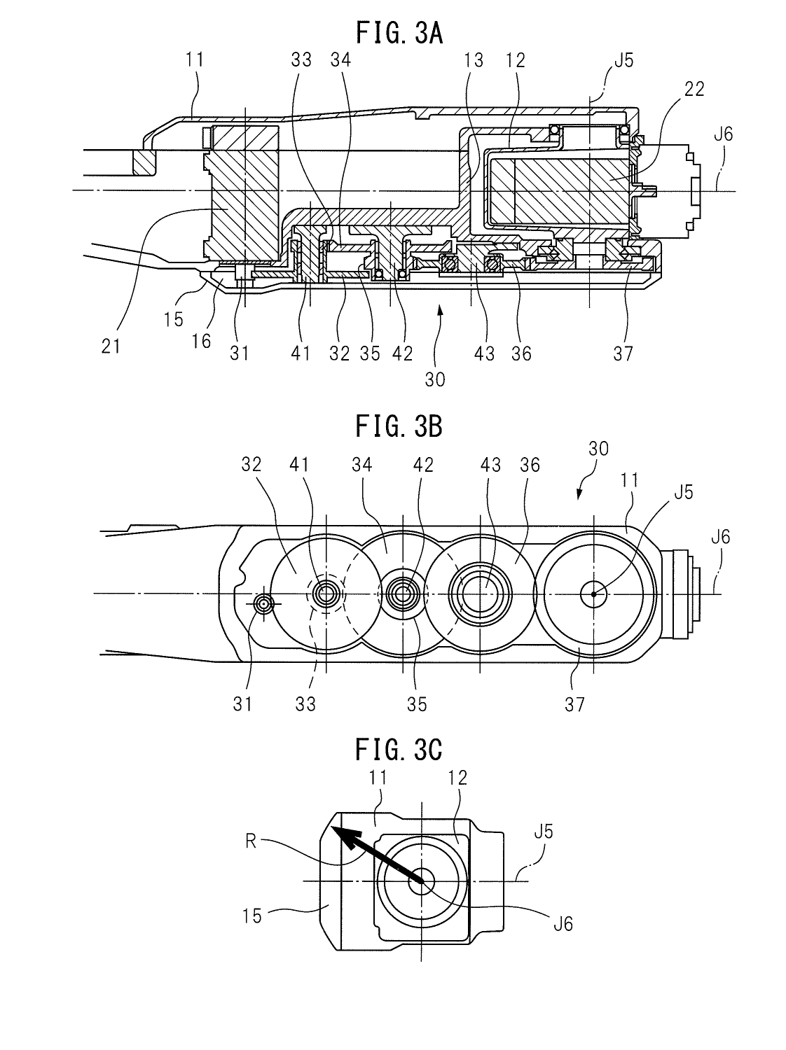

FIG. 3A is a sectional view of the wrist configuration unit based on the present invention. FIG. 3B is a side view illustrating a state where the cover of the wrist configuration unit illustrated in FIG. 3A is detached. In the following, the spur-gear speed-reduction mechanism unit 30 will be described with reference to FIGS. 2 to 3B.

As illustrated in FIG. 3A, in the wrist inner frame 11, the wrist housing machine frame 13 is arranged. As can be seen from FIG. 3A, the wrist housing machine frame 13 partitions an inside of the wrist machine frame 11 into a plurality of wrist rooms. In one wrist room among these wrist rooms, the wrist inner frame 12 is arranged so as to be rotatable on the axis J5. As illustrated in the drawing, a driving motor 22 for driving the working tool 3 (not illustrated in FIG. 3A) is arranged in the wrist inner frame 12.

A wrist inner frame driving motor 21 that drives and rotates the wrist inner frame 12 is arranged in another wrist room. As illustrated in FIG. 3A, the wrist inner frame driving motor 21 is arranged such that an output shaft of the motor 21 is perpendicular to a center axis (that is the same as the axis J6 in FIG. 3A) of the wrist 2.

Further, one side of the wrist housing machine frame 13 is covered with the cover 15. A space between the cover 15 and the wrist housing machine frame 13 is a speed reducer room 16. In the speed reducer room 16, the spur-gear speed-reduction mechanism unit 30 is arranged.

The spur-gear speed-reduction mechanism unit 30 mainly includes a first spur gear 31 to a seventh spur gear 37, and a first auxiliary shaft 41 to a third auxiliary shaft 43. As illustrated in FIG. 3A, the first spur gear 31 is attached to the output shaft of the wrist inner frame driving motor 21. The first auxiliary shaft 41, the second auxiliary shaft 42, and the third auxiliary shaft 43 that are parallel with the output shaft of the wrist inner frame driving motor 21 were arranged on one side of the wrist housing machine frame 13. As can be seen from FIG. 3B, the first auxiliary shaft 41 to the third auxiliary shaft 43 are perpendicular to the center axis of the wrist 2.

The second spur gear 32 is rotatably supported by the first auxiliary shaft 41, and engages the first spur gear 31. As illustrated such as in FIG. 3A, a diameter of the second spur gear 32 is larger than a diameter of the first spur gear 31. According to one embodiment, a diameter of the second spur gear 32 is approximately four times as large as a diameter of the first spur gear 31.

As can be seen from FIGS. 3A and 3B, the third spur gear 33 integrated with the second spur gear 32 is rotatably supported by the first auxiliary shaft 41. As illustrated in FIG. 3A, a distance from the third spur gear 33 to the center axis of the wrist 2 is smaller than a distance from the second spur gear 32 to the center axis of the wrist 2.

A diameter of the second spur gear 32 is larger than a diameter of the third spur gear 33. According to one embodiment, a diameter of the second spur gear 32 is approximately four times as large as the diameter of the first spur gear 31. The third spur gear 33 engages the fourth spur gear 34 rotatably supported by the second auxiliary shaft 42.

As can be seen from FIGS. 3A and 3B, the fifth spur gear 35 integrated with the fourth spur gear 34 is rotatably supported by the second auxiliary shaft 42. As illustrated in FIG. 3A, a distance from the fifth spur gear 35 to the center axis of the wrist 2 is larger than a distance from the fourth spur gear 34 to the center axis of the wrist 2.

A diameter of the fourth spur gear 34 is larger than a diameter of the fifth spur gear 35. According to one embodiment, diameter of the fourth spur gear 34 is approximately four times as large as a diameter of the fifth spur gear 35. The fifth spur gear 35 engages the sixth spur gear 36 rotatably supported by the third auxiliary shaft 43. The sixth spur gear 36 functions as an idler gear.

Further, as can be seen in FIG. 3A and 3B, the seventh spur gear 37 is rotatably supported by the rotational axis J5 of the wrist inner frame 12. The seventh spur gear 37 engages the sixth spur gear 36. Rotation of the sixth spur gear 36 is transmitted to the seventh spur gear 37 so that the wrist inner frame 12 can be rotated on the rotational axis J5. Accordingly, the seventh spur gear 37 functions as an output spur gear.

At the time of operation, driving torque of the wrist inner frame driving motor 21 is transmitted via the first spur gear 31 to the second spur gear 32. Then, the driving torque is transmitted, via the third spur gear 33 integrated with the second spur gear 32, to the fourth spur gear 34. Then, the driving torque is transmitted, via the fifth super gear 35 integrated with the fourth spur gear 34, to sixth spur gear 36 to be transmitted to via the sixth spur gear 36 to the seventh spur gear 37. Thereby, the driving torque of the wrist inner frame driving motor 21 is transmitted to the seventh spur gear 37 so that the wrist inner frame 12 can be rotated on the rotational axis J5.

An output shaft of the driving motor 22 arranged in the wrist inner frame 12 is connected to a different speed reducer that is not illustrated in the drawings. Thereby, rotation of the driving motor 22 is decelerated, and driving force of the driving motor 22 rotates the working tool attachment unit 18. The different speed reducer may be incorporated in the working tool attachment unit 18. In many cases, a size of the driving motor 22 is set to be the same as a size of the wrist inner frame driving motor 21, in accordance with specifications of the output shaft of the driving motor 22. A length of the driving motor 22 in the direction of the axis J6 is approximately the same as a diameter of the seventh spur gear 37.

According to the present invention, the seventh spur gear 37 as the output spur gear engages the sixth spur gear 36 as the idler gear. The fifth spur gear 35 having a small diameter engages the sixth spur gear 36, on the opposite side of an engagement position between the seventh spur gear 37 and the sixth super gear 36. With such a configuration, unlike the prior art, the fourth spur gear 34 integrated with the fifth spur gear 35 can be arranged such that a distance between the fourth spur gear 34 and the center axis of the wrist is smaller than a distance between the first spur gear 31 and the center axis of the wrist. Further, the fifth spur gear 35 can be arranged at a position distant from the center axis of the wrist.

As a result, a distance between the wrist housing machine frame 13 and the cover 15 that covers the speed reducer room 16 can be minimized. In other words, according to the present invention, a width of the wrist machine frame 11 in the direction of the rotational axis J5 of the wrist inner frame 12 can be made small.

FIG. 3C is an end view when seen from a wrist tip of the wrist configuration unit illustrated in FIG. 3A. As illustrated in FIG. 3C, a distance from the axis J6 to a portion of the cover 15 that is the most distant from the axis J6 is an interference radius R of the wrist 2. According to the present invention, the above-described configuration enables a size of the wrist machine frame 11 to be decreased in the direction of the rotational axis J5. As a result, a size of the cover 15 can be decreased in the direction of the rotational axis J5, as well. In other words, according to the present invention, it can be understood that the interference radius R of the wrist can be made small compared with the prior art.

A diameter of the first spur gear 31 is determined by the number of teeth and a tooth shape size (that is referred to as a module, in the following). A diameter of the second spur gear 32 engaging the first spur gear 31 is determined by a speed ratio of the first spur gear 31 to the second spur gear 32. Since modules of gears engaging each other need to be set the same, the speed ratio is a ratio of the number of the teeth of the second spur gear 32 to the number of the teeth of the first spur gear 31. In order to reduce a diameter of the second spur gear 32 to minimize a height of the cover 15, the number of the teeth of the second spur gear 32 is decreased to reduce the speed ratio, or a diameter of the first spur gear 31 is reduced. Reducing the speed ratio decreases output torque. Reducing a diameter of the first spur gear 31 makes a module smaller, so that a tooth surface lacks strength. In many cases, the number of the teeth of the first spur gear 31 is set to be the minimum number of the teeth, on the basis of a diameter of a shaft of the wrist inner frame driving motor 21, and a module.

According to the present invention, a speed ratio of the second spur gear 32 to the first spur gear 31, a speed ratio of the fourth spur gear 34 to the third spur gear 33, and a speed ratio of the sixth spur gear 36 to the fifth spur gear 35 are approximately 1:4. Thus, each speed ratio between the spur gears is approximately the same, and therefore a height of the cover 15 can be kept to the bare minimum. In the above-described case, when the maximum revolution number of the wrist inner frame driving motor 21 is 5000 rpm, the maximum speed of the rotational axis J5 is set as 400 deg/sec.

Preferably, the wrist inner frame 12 integrated with the driving motor 22 and the working tool attachment unit 18 is arranged such that a center of the wrist inner frame 12 in a longitudinal direction thereof is positioned on the rotational axis J5. The reason of this is that the wrist inner frame 12 is balanced. In other words, when the wrist inner frame 12 protrudes outward in the direction of the axis J6, it becomes difficult to attach the heavy working tool 3 to the working tool attachment unit 18. When the wrist inner frame 12 retreats inward in the direction of the axis J6, the wrist inner frame 12 more easily interferes with the umbilical member 4 for the working tool. For this reason, as illustrated in FIG. 3A, the third auxiliary shaft 43 of the sixth spur gear 36 that engages the seventh spur gear 37 is preferably arranged at a position corresponding to a rear end of the driving motor 22.

Further, in order to set the interference radius R illustrated in FIG. 3C to be small, a width of the wrist inner frame 12 in the direction of the rotational axis J5 is minimized, as well. The seventh spur gear 37 is arranged at a position distant from the center axis of the wrist. To obtain this configuration, the sixth spur gear 36 as an idler gear needs to be provided. When the sixth spur gear 36 is not provided, the fourth spur gear 34 needs to be arranged at a position distant from the center axis of the wrist 2 as in the prior art.

For this reason, according to the present invention, the interference radius R from the axis J6 can be made small while maintaining advantages of the spur-gear speed-reduction mechanism unit 30 such as simplicity and easiness of maintenance work, simplicity of configuration, and reduction in manufacturing cost.

Incidentally, as can be seen with referring to FIG. 3A, a distance between the center axis of the wrist 2 and a tip of the output shaft of the wrist inner frame driving motor 21 is larger than a distance between the center axis of the wrist 2 and any of the first spur gear 31 to the seventh spur gear 37. In other words, the tip of the output shaft of the wrist inner frame driving motor 21 protrudes outwardly rather than the first spur gear 31 to the seventh spur gear 37. In this case, a large part of the wrist machine frame 11 can be prevented from protruding outward, so that a width of the wrist 2 in the direction of the rotational axis J5 can be further decreased. Further, in this configuration, moment acting on a bearing in the wrist inner frame driving motor 21 can also be made small, so that a bearing does not need to be arranged outside the wrist inner frame driving motor 21.

### ADVANTAGE OF THE INVENTION

According to a first aspect, the seventh spur gear as the output spur gear engages the sixth spur gear as an idler gear. The fifth spur gear having a small diameter engages the sixth spur gear, on the opposite side of the engagement position between the seventh spur gear and the sixth spur gear. Unlike the prior art, this configuration enables the fourth spur gear integrated with the fifth spur gear to be arranged at a position close to the center axis of the wrist, and enables the fifth spur gear to be arranged at a position distant from the center axis of the wrist. As a result, a distance between the cover covering the speed reducer room and the wrist housing machine frame can be minimized. In other words, a width of the wrist machine frame in the direction of the rotational axis of the wrist inner frame can be made small. Accordingly, an interference radius when seen from a front of the wrist can be made small, as well.

According to a second aspect, when the tip of the output shaft of the wrist inner frame driving motor protrudes outwardly rather than the first to seventh spur gears, even if an entire length of the wrist inner frame driving motor is long, the spur-gear speed-reduction mechanism unit can be arranged so as to be close to the center axis of the wrist. Accordingly, an interference radius when seen from a front of the wrist can be made still smaller.

The present invention was described above by citing the typical embodiments. However, a person skilled in the art would understand that the above-described alteration, and other various alteration, omission and addition can be made without departing from the scope of the present invention.

What is claimed is:

1. A wrist configuration unit that is connected to a tip of an arm of a robot, and that has a plurality of operational degrees of freedom, the wrist configuration unit comprising:
a wrist housing machine frame that forms, in a wrist machine frame, different wrist rooms separated from each other;
a wrist inner frame that is rotatably held in one wrist room of the wrist rooms;
a wrist inner frame driving motor that drives the wrist inner frame, and that is arranged in another wrist room of the wrist rooms such that an output shaft of the wrist inner frame driving motor is parallel with a rotational axis of the wrist inner frame;
an additional driving motor that is received in the wrist inner frame, and that outputs rotational output on an axis perpendicular to the rotational axis of the wrist inner frame;
a cover that covers one side of the wrist housing machine frame, and that forms a speed reducer room; and
a spur-gear speed-reduction mechanism unit that is arranged in the speed reducer room, and that decelerates a force of rotation output from the output shaft of the wrist inner frame driving motor, and transmits the force of the rotation to the wrist inner frame,
wherein the spur-gear speed-reduction mechanism unit comprises:
a first spur gear attached to the output shaft of the wrist inner frame driving motor;
a second spur gear that is rotatably supported by a first auxiliary shaft attached to the wrist housing machine frame, that has a diameter larger than a diameter of the first spur gear, and that engages the first spur gear;
a third spur gear that is rotatably supported by the first auxiliary shaft so as to be integrated with the second spur gear, and that has a diameter smaller than the diameter of the second spur gear;
a fourth spur gear that is rotatably supported by a second auxiliary shaft attached to the wrist housing machine frame, that has a diameter larger than the diameter of the third spur gear, and that engages the third spur gear;
a fifth spur gear that is rotatably supported by the second auxiliary shaft so as to be integrated with the fourth spur gear, and that has a diameter smaller than the diameter of the fourth spur gear;
a sixth spur gear that is rotatably supported by a third auxiliary shaft attached to the wrist housing machine frame, that has a diameter larger than the diameter of the fifth spur gear, and that engages the fifth spur gear; and
a seventh spur gear that is attached to the rotational shaft of the wrist inner frame, and that engages the sixth spur gear,
wherein the fourth spur gear is arranged such that a distance between the fourth spur gear and the wrist housing machine frame is smaller than a distance between the first spur gear and the wrist housing machine frame.

2. The wrist configuration unit according to claim 1, wherein a tip of the output shaft of the wrist inner frame driving motor protrudes outwardly rather than the first to seventh spur gears.
